(19) United States
(12) Patent Application Publication
(10) Pub. No.: US 2022/0367164 A1
(43) Pub. Date: Nov. 17, 2022

(54) MICROFABRICATED ION TRAP WITH IMPROVED THERMAL CHARACTERISTICS

(71) Applicant: National Technology & Engineering Solutions of Sandia, LLC, Albuquerque, NM (US)

(72) Inventors: Matthew G. Blain, Albuquerque, NM (US); Christopher Nordquist, Albuquerque, NM (US); Peter Lukas Wilhelm Maunz, Albuquerque, NM (US)

(21) Appl. No.: 17/870,465

(22) Filed: Jul. 21, 2022

Related U.S. Application Data
(62) Division of application No. 17/065,759, filed on Oct. 8, 2020.
(60) Provisional application No. 62/932,141, filed on Nov. 7, 2019.

(51) Int. Cl. H01J 49/00; G06N 10/00

(52) U.S. Cl. CPC H01J 49/0018; G06N 10/00; H01J 3/40

(57) ABSTRACT

In an ion trap chip, an RF electrode for producing a radio-frequency ion-trapping electric field is formed in one of a plurality of metallization layers formed on a substrate and separated from each other by intermetal dielectric. At least two spans of the RF electrode are suspended between support pillars over a void defined within one or more layers of intermetal dielectric. For each span that is suspended between a first and a second support pillar, an area A_{Total} and an area A_{Supported} are defined. A_{Total} is the total electrode area from an initial edge of the first support pillar to an initial edge of the second support pillar. A_{Supported} is the electrode area directly underlain by the first support pillar. In each span that is suspended from a first support pillar to a second support pillar, A_{Supported} is not more than one-half of A_{Total}.

### CROSS-REFERENCE TO RELATED APPLICATION

This application is a divisional application of parent patent application U.S. application Ser. No. 17/065,759, filed Oct. 8, 2020, and titled “MICROFABRICATED ION TRAP WITH IMPROVED THERMAL CHARACTERISTICS.” The present application claims the priority of its parent application, which is incorporated herein by reference. This application further claims the benefit of U.S. Provisional Application No. 62/932,141, filed on Nov. 7, 2019, the entirety of which is hereby incorporated herein by reference.

ACKNOWLEDGEMENT OF GOVERNMENT SUPPORT

This invention was made with Government support under Contract No. DE-NA0003525 awarded by the United States Department of Energy/National Nuclear Security Administration. The Government has certain rights in the invention.

### FIELD OF THE INVENTION

The invention relates to a method for fabricating ion traps for quantum information processing.

### ART BACKGROUND

It has long been known that isolated atomic ions can be confined in so-called “ion traps” constituted by superposed electrostatic and radio frequency (RF) fields. The technology of ion traps was first developed for applications in mass spectrometry. More recently, however, researchers in the field of quantum information processing have recognized that an ensemble of trapped atomic ions is a promising host system for the operations that underlie quantum computation. Atomic energy levels can be used to encode quantum bits (qubits) in trapped ions and optical, RF, or microwave energy can be used realize quantum gates between these qubits. Coherence times that are ample for quantum computation have been demonstrated. Techniques have been developed for storing and transporting pluralities of trapped ions.

It has been known since the publication of Earnshaw's theorem in 1842 that a charged particle cannot be stably trapped solely with electrostatic fields. Instead, ion traps rely at least in part on the ponderomotive force exerted on ions by an oscillatory (ac) field, typically at radio frequency. The ponderomotive force can be understood intuitively as the time-averaged effect on the position of an ion driven by a spatially inhomogeneous, oscillating electric field. Within each cycle of the oscillating field, the ion will be displaced farther during the half-cycle when the field is stronger at the ion's initial position. The net effect is to urge the ion in the direction of decreasing field strength, irrespective of the polarity of the ionic charge.

Quantitatively, a pseudopotential ψ(x) is defined in terms of the charge q and mass m of the ion and the angular frequency Ω and electric field strength E(x) of the RF field by:

$$ψ ( x ) = \frac{q}{4 m {Ω}^{2}} {E}^{2} ( x ) .$$

The ponderomotive force Fₚ(x) is proportional to the gradient of the pseudopotential; that is,

Fₚ(x)=−q∇ψ(x)

The trap center is at the null of the ac electric field, which leads to the minimum of the RF pseudopotential. The trapped ions oscillate about this RF null. These oscillations are referred to as secular motion, with secular frequencies ωᵢ. Under the assumption of small-amplitude harmonic motion about the RF null, and assuming that the magnitude of the electric field varies as 1/r, where r is the distance from the potential minimum, the secular frequencies are approximated by

$${ω}_{i} = \frac{q}{2 m Ω} \sqrt{{\partial }_{i}^{2} {E}^{2} ( x )} .$$

It will be understood from the above equation that the secular frequencies are determined by the curvature of the pseudopotential.

In stable traps, the secular frequencies are smaller than the RF frequency Ω. A stability factor qₛ is defined by qₛ=2\sqrt{2}(ωᵢ/Ω). Stability of ions in the trap is described by the stability diagram for Mathieu's differential equation. For qₛ<0.9 and small control voltages, traps are stable.

Ion traps that rely on an RF null in the pseudopotential are often referred to as Paul traps, in recognition of the pioneering work of Wolfgang Paul in the 1950s. The trap that Paul demonstrated in 1954 used a quadrupole RF field produced by a ring electrode describing a hyperboloid of revolution about a central axis, and two hyperbolic end-cap electrodes situated at opposite positions along the central axis.

Geometrically, the hyperbolic Paul trap is a bulk three-dimensional (3D) trap. The RF null is point-like, which limits the trap occupancy with minimal micro-motion at any given time to a single particle.

The principles mentioned above are discussed more fully in D. Leibfried, R. Blatt, C. Monroe, and D. Wineland. “Quantum Dynamics of Single Trapped Ions.” Reviews of Modern Physics 75, no. 1 (Mar. 10, 2003): 281-324, https://doi.org/10.1103/RevModPhys.75.281.

A further development is the linear 3D trap, which extends the RF null into a nodal line along a central symmetry axis of the device. Four rod-shaped electrodes, arranged in opposing pairs, are arrayed about the central axis. One pair is grounded, and the other pair is excited with the RF input signal. Axial confinement is provided by static voltages applied to the endcaps.

The linear 3D trap was first introduced in 1989. (See, for example, J.D. Prestage et al., J. Appl. Phys. 66.3 (1989), 1013-1017.) In more recent developments, the three-dimensional conformation of the electrodes has been unfolded and mapped to a two-dimensional (2D) surface to produce a surface RF trap. Unlike the bulk traps, the surface traps permit optical access to the trapped ions over a full hemisphere.

An early design for a surface RF trap was described in J. Chiaverini et al., “Surface-Electrode Architecture for Ion-Trap Quantum Information Processing,” Quantum Info. and Comp. 5 (2005) 419-439. In that design, there are five coplanar, rectilinear electrodes. The center electrode and the two outer electrodes are maintained at RF ground, and the RF signal is applied to the other two electrodes. The RF null is in a line above and parallel to the center electrode. This line coincides with the z-axis, i.e. the principal axis of the trap in the longitudinal direction. Importantly, the two outer electrodes can be subdivided into segments for independent application of static (dc) potentials that can be varied in the longitudinal direction for purposes of longitudinal confinement and various types of control.

The other two principal axes lie in a plane perpendicular to the z-axis. Because of the mirror symmetry of the five-electrode design, the x- and y-axes are respectively parallel and perpendicular to the electrode plane.

It is noteworthy, however, that the x- and y-axes can be rotated within their plane by changing the relative widths of the respective electrodes in a manner that breaks the mirror symmetry.

Chiaverini et al. predicted that a five-electrode surface RF trap would be able to trap ions at a distance of about 50 μm above the electrode plane. For an input RF signal 100V in amplitude and 100 MHz in frequency, the predicted secular frequencies would be in the range of 10 MHz.

A four-electrode surface RF trap was reported in S. Seidelin et al., “Microfabricated Surface-Electrode Ion Trap for Scalable Quantum Information Processing,” Phys. Rev. Lett. 96 (2006) 253003-1 to 253003-4. In that design, the two RF electrodes alternated with the two dc control electrodes. One of the control electrodes was subdivided into four independent segments. RF grounds for the control electrodes were provided by 820-pf capacitors.

The z-axis of the Seidelin et al. trap was about 40 μm above the electrode plane. The RF input signal had an amplitude of about 46V to about 103V and a frequency of about 87 MHz. The longitudinal secular frequency was in the range 1.84-2.85 MHz, and the other two measured secular frequencies were in the range 15.78-17.13 MHz for an input RF amplitude of 103.2V, and in the range 5.28-8.29 MHz for an input RF amplitude of 46.1V. The x and y principal axes were inclined at about 45° to the electrode plane.

Subsequent surface RF traps have been made with multiple levels of metallization. Additional levels of metallization are useful for shielding and for routing of voltages and ground connections. For example, D. Stick et al., “Demonstration of a microfabricated surface electrode ion trap,” dated Oct. 23, 2018, arXiv:1008.0990v2 [physics.ins-det] (16 Nov. 2010) (four pages), reported a symmetrical four-electrode trap fabricated on an SOI wafer. The electrodes were fabricated in a top metal layer separated by 9-14 μm of insulating oxide from an aluminum ground plane. The dc electrodes were segmented to provide a total of 42 control electrodes. An insulating dielectric separated the ground plane from the top silicon of the wafer. The insulating oxide was formed by deposition into supporting pillars for features of the top metal, including the trap electrodes, their leads, and outside grounded regions.

Exposed dielectrics are liable to collect stray charges that can shift the trapping potentials. To mitigate this problem, trap electrodes and other features of the top metal were made to overhang their supporting oxide pillars by 5 μm. This was intended to reduce line-of-sight exposure of the trapped ions to the dielectric surfaces. The overhang distance was a controllable value achieved by using vertical etch stops around the pillars.

The overhangs had the additional benefit of permitting metal to be vertically deposited over the electrode layer without shorting the electrodes.

Ions were loaded from the backside of the wafer through a hole that extended the entire length of the trapping region.

The trap was operated with RF drive frequencies spanning the range at least from 27 MHz to 43 MHz. The amplitude of the drive signal was in the range 50V-200V. Ions were observed to be trapped 80 μm above the electrode plane. Typical observed secular frequencies were 1 MHz axial and 4 MHz radial. A dc offset applied to the RF electrodes was able to change the radial secular frequencies and to rotate the principal axes. The control electrodes were used to demonstrate repeated shuttling of a trapped ion over half the length of the trapping structure, which encompassed ten electrodes over a distance of 770 μm.

Surface ion traps laid out in two dimensions are necessary for operations in which ion chains are split, recombined, and reordered. Accordingly, junction traps have been designed in which three, or even four, linear traps intersect in a junction region. The junction, however, has been found to cause pseudopotential barriers that may be comparable in height to the trap depth. Loading holes can also cause troublesome pseudopotential barriers. Hence, there has been an effort to find design modifications that reduce the pseudopotential barriers arising from both causes.

A surface ion trap with Y-shaped junctions (a so-called “Y-junction trap”) was reported in D.L. Moehring et al., “Design, fabrication and experimental demonstration of junction surface ion traps,” New J. Phys. 13 (2011) 075018 (eight pages). The design of the individual linear traps was similar to that reported in D. Stick et al., cited above. In total, the Y-junction trap had 47 independent dc electrodes.

The RF drive signal had a frequency of about 43 MHz. The rf amplitude was varied from 25V to 165V for trapping in the loading hole, and from 85V to 120V for junction shuttling. The measured height of the trapped ions above the electrode plane (after shuttling from the loading hole) was about 70 μm.

A known technique for locally changing the magnitude and slope of the equilibrium pseudopotential is to spatially modulate the edges of the electrodes. Moehring et al. applied spatial modulation to the dc and RF electrodes near the junction and the loading hole to reduce the pseudopotential barriers caused by those features while maintaining the trapping node within a specified height range above the electrode plane.

More specifically, device performance was predicted from boundary element method (BEM) calculations of the electrostatic field. The electrode geometry for each calculation was specified by a set of parameters defining the electrode shapes in terms of planar polygons in three spatial dimensions. The design was iterated in order to minimize a cost function over the parameter space. The cost function included contributions from the ion height, the pseudopotential values, and the pseudopotential derivatives along the equilibrium trap axis of one arm of the Y-junction.

Experiments performed on fabricated Y-junction traps verified the repeated shuttling of ions in a round trip of about 30 μm that went up and back through each of the three arms of the junction. High degree-of-freedom (DOF) shuttling routines were successfully performed using 25 dc electrodes at a time for linear shuttling and 35 dc electrodes at a time for junction shuttling. Reduced DOF routines were also successfully performed, using the nearest seven dc electrodes at a time in the linear regions and the central 13 dc electrodes in the junction region.

In more complex shuttling routines, three ions were consecutively loaded and independently shuttled into each arm of the junction. Reordering within linear ion chains was demonstrated by splitting the chains, independently shuttling the ions through the junction, and recombining the chains.

A linear surface ion trap can support a chain of trapped ions that are localized at the nodal line and confined within the same potential well. Because there is strong ion-to-ion coupling of the ionic motion in such a trapped chain, the normal modes of the chain form a useful basis of eigenfunctions for describing the collective motion in such a system. Quantum gates between different ions can be realized through operations that affect the collective motion and the internal states of individual ions.

In addition to linear traps, so-called “point-Paul traps” are also of interest for quantum information processing. In a point-Paul trap, the ions are trapped at a nodal point of a three-dimensional quadrupole field. Although in principle such a trap can simultaneously trap multiple ions, micromotion can be minimized for only a single trapped ion. (It will be recalled that “micromotion” is the deterministic motion of the ion at the frequency of the applied RF field.)

If the spacing among multiple point-Paul traps is close enough, the Coulomb repulsion between electrons occupying neighboring traps causes coupling that can be exploited to realize quantum gates.

Although surface ion traps are demonstrably useful, there are still technological challenges to be overcome before these devices can find broad application in quantum information processing. One of these challenges is the problem of ion heating, which, among other undesirable effects, tends to disturb the ionic motion, destabilize trapped ion chains, and limit the fidelity of quantum gates.

Another challenge is posed by trap heating effects due to RF dissipation, which have impeded efforts to operate traps at very low temperatures.

Efforts are underway to better understand the sources of ionic heating, and to decrease power requirements so that power dissipation in the trapping structures can be reduced.

### SUMMARY OF THE INVENTION

For applications in quantum information processing, it is important to realize a well-defined and stable ionic oscillation frequency of sufficient magnitude to achieve the requisite ponderomotive potential, which determines the trap depth. To keep trapping potentials constant, it is also important to stabilize the temperature of the ion trap.

However, the RF electrode exhibits capacitive coupling to the surrounding trap electrodes and to the return paths on grounded conductive traces. RF dissipation effectuated by this capacitive coupling generates heat that can cause unacceptable temperature excursions in the trap.

We have found that the parasitic capacitance can be reduced by removing a significant fraction of the insulating dielectric materials from around and under the RF electrode and the other trap electrodes, thus mitigating the RF heating.

The insulating dielectric material is removed from around and under the RF electrode by etching away some of the dielectric material while leaving the conductive metal trace of the RF electrode in place. This etch is performed by a selective technique that leaves intentional dielectric material in place to serve as mechanical supports for the RF electrode. This leads to an air-bridged RF electrode with dielectric supports. The capacitance to nearby metal conductors is reduced, and dielectric heating is reduced, because there is less intervening dielectric material.

The selective etch of the dielectric is deterministic. That is, it must stop at the surface of a third material layer that is designed to serve as the etch stop. The etch stop material is different from the electrode metal and from the insulating dielectric.

In alternative implementations, the etch-stop material could be a metal, a semiconductor, or a dielectric. Depending on the specific application, it could be removed or left in place. In this regard, we refer to a metal or semiconductor etch stop as “sacrificial” if it is removed after the selective dielectric etch by a technique that is inert toward the remaining dielectric and the electrode metal.

The principle of selective etching to create dielectric support pillars is described, for example, in D. Stick et al., arXiv:1008.0990v2, which was cited above. As described there, oxide pillars are grown in multiple states of plasma-enhanced chemical vapor deposition (PECVD) and encased in a vertical layer of etch stop material. The deterministic etch that stops on this layer creates an overhang. That is, the top metal layer of the trap structure, including electrodes, leads, and outside grounded regions, overhangs the supporting pillars by a distance of 5 μm.

The RF electrode in embodiments that we envisage is a thin, elongated metal beam supported from below, at intervals, by dielectric pillars. Such a structure presents challenges that were not considered in the article by D. Stick et al. These challenges include vibrational modes of the RF electrode that might produce intolerable vertical displacements, especially at mechanical resonant frequencies. Extensive modeling studies were performed in order to find a design space that was free of intolerable vibrational resonances and that offered significant reductions in RF heating.

Accordingly, the invention relates to an ion trap chip of the kind in which an RF electrode for producing a radio-frequency ion-trapping electric field is formed in one of a plurality of metallization layers formed on a substrate and separated from each other by intermetal dielectric.

At least two spans of the RF electrode are suspended between support pillars over a void defined within one or more layers of intermetal dielectric. For each span that is suspended between a first and a second support pillar, an area A_{Total} and an area A_{Supported} are defined. A_{Total} is the total electrode area from an initial edge of the first support pillar to an initial edge of the second support pillar. A_{Supported} is the electrode area directly underlain by the first support pillar. In each span that is suspended from a first support pillar to a second support pillar, A_{Supported} is not more than one-half of A_{Total}.

In embodiments, the intermetal dielectric is composed of silicon dioxide.

In embodiments, the substrate is a silicon substrate.

In embodiments, the RF electrode is formed in a top metallization layer.

In embodiments, each span has a total length in the range 35 μm-100 μm.

### BRIEF DESCRIPTION OF THE DRAWINGS

FIG. 1 is a cross-sectional cartoon view of an example ion trap that uses two metallization layers.

FIG. 2 is an overhead view of the ion trap of FIG. 1.

FIG. 3 is an overhead view of a fabricated prototype similar to the ion trap of FIGS. 1 and 2. The loading hole and part of the electrode layout are visible in the figure.

FIG. 4 is a detail of the prototype of FIG. 3, shown in perspective view. Visible features in the figure include portions of the loading hole, the two inner dc electrodes bracketing the loading hole, and the RF electrode.

FIG. 5 is a notional cartoon view, in cross-section, of an example ion trap that uses four metallization layers. The figure is highly simplified and its scale is grossly distorted for clarity of presentation.

FIGS. 6A and 6B provide a cross-sectional view, approximately to scale, of the slotted quantum region of an ion trap fabricated in four metallization layers. FIG. 6B is a detail of FIG. 6A.

FIG. 7 is a plan view of a complete ion trap chip, in an illustrative example.

FIG. 8 is a cutaway perspective view of a portion of a suspended RF electrode, including a capacitively coupled RF amplitude sensor.

FIG. 9 is an elevational sectional view of the RI amplitude sensor of FIG. 8.

FIG. 10 is a cartoon drawing, in cross-section, of part of an example ion-trap chip. The chip has six metallization levels; the top three levels are included in the figure. The portion shown is taken from a region that includes part of the RF electrode.

FIGS. 11A, 11B, and 12 show a portion of an RF electrode in an example implementation. FIG. 11A is a perspective view of one pillar together with the overlying portion of the RF electrode. FIG. 11B is a perspective view of two pillars together with the overlying span of the RF electrode. FIG. 12 is a view of a pillar in cross-section. The figures are notional only, and they are not drawn to scale.

### DETAILED DESCRIPTION

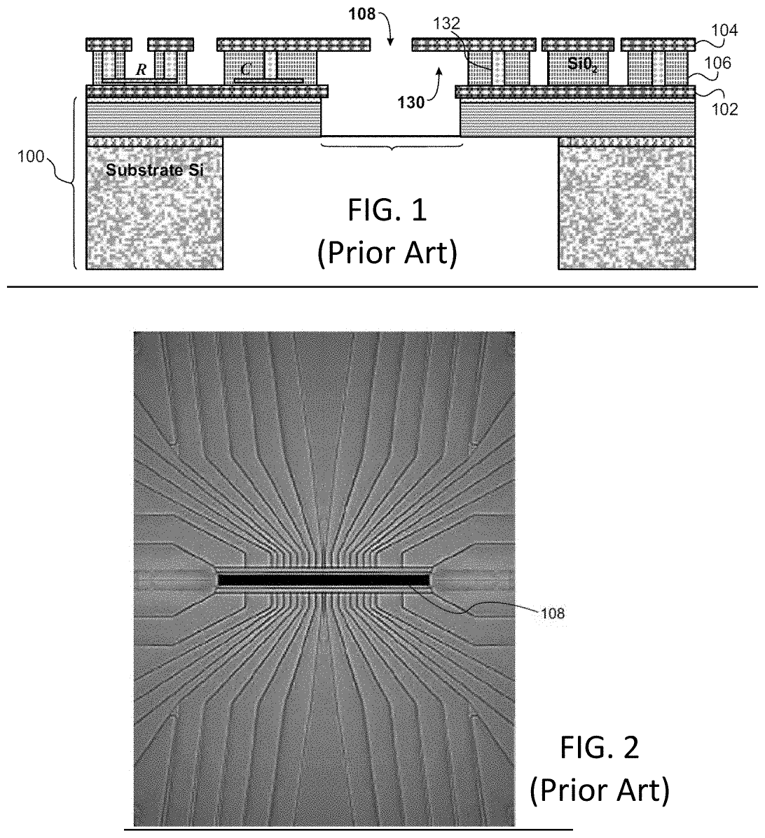

FIGS. 1 and 2 provide schematic views of an example ion trap of the kind reported in D. Stick et al., arXiv:1008.0990v2, cited above. The ion trap described here is offered solely for illustrative purposes and is not meant to be limiting.

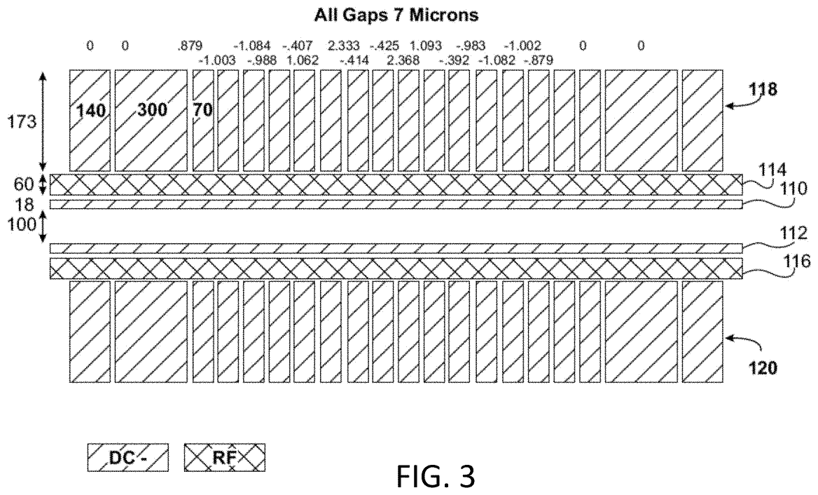

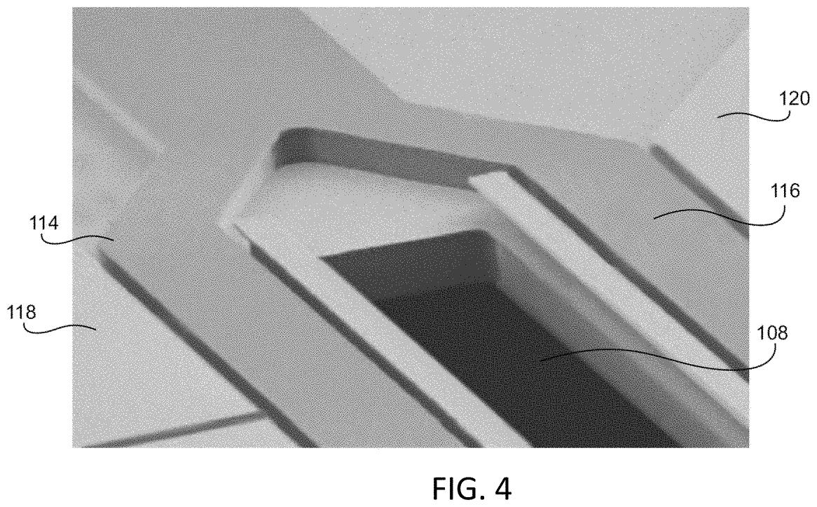

FIG. 1 is a cross-sectional view of the ion trap, and FIG. 2 is an overhead view. FIG. 3 is an overhead view of a fabricated prototype, showing the loading hole and part of the electrode layout. FIG. 4 is a detail in perspective view, showing portions of the loading hole, the two inner dc electrodes bracketing the loading hole, and the RF electrode.

The device is fabricated on an SOI wafer 100 using known photolithographic techniques and other techniques of CMOS and MEMS processing. It includes two metal layers 102, 104 (M1 and M2) separated by an insulating layer 106 of silicon dioxide. Geometrically, the trap has a symmetric six-rail design with a 100-μm-wide slot 108 (the “loading hole”) etched through the substrate to allow for backside ion loading and optical access.

It should be noted in this regard that although silicon dioxide is a typical dielectric material to interpose between metallization levels, alternative materials are feasible and are not excluded from the scope of the present invention. Some possible alternatives include, without limitation, aluminum nitride, silicon nitride, alumina, diamond, and silicon carbide. Several of these alternatives, such as diamond, offer the benefit of high coefficients of thermal conductivity, which is helpful for thermal management in the ion trap. Although some of these materials have undesirably high dielectric constants, that disadvantage may in some cases be offset by the advantage of high thermal conductivity. In this and further illustrative embodiments described below, the interlevel dielectric is silicon dioxide, also referred to as “oxide”. However, this is by way of example only, and it should not be understood as excluding other material choices.

Likewise, although a silicon or SOI wafer constitutes a typical substrate, other insulating or semiconducting materials may be suitable substrate materials and are not excluded from the scope of the present invention. Some possible alternative materials include, without limitation, silicon dioxide, alumina, silicon carbide, diamond, and gallium arsenide and other III-V semiconductors.

Adjacent to the slot, as best seen in FIG. 3, are split central control electrodes 110, 112, two electrodes 114, 116 with RF voltages applied, and forty outer segmented control electrodes 118, 120. The control electrodes (also referred to as “dc electrodes”) have quasistatic voltages applied to them.

As best seen in FIG. 1, the oxide layer 106, 14 μtm thick, separates the top metal layer from the bottom metal layer. Each metal layer is aluminum, 2.4 μm thick.

Turning back to FIG. 3, the two RF rails 114, 116 are each 60 μm thick and are separated by 140 μm. The combined capacitance of the RF rails is about 7 pF to RF ground.

The equilibrium trapping position is about 80 μm above the trap surface.

Turning again to FIG. 1, the oxide insulating layer 106 is controllably etched back to expose the RF ground plane 102 in M1 directly beneath the electrodes, and to recess the oxide support walls for the electrodes in M2. Because of this recess 130, the electrode metal overhangs the oxide, thus reducing the amount of insulator exposed to a line-of-sight from the trapping region. One benefit of this overhang is that it enables a metal of choice to be evaporated onto the top electrodes without causing short circuits.

The electrical connections 132 between metallization layers, as seen in FIG. 1, are made by 2.7-μm via technology.

Optionally, the exposed silicon surfaces can be evaporatively coated with a ground layer, for example a 500-nm layer of gold.

The implementation shown in FIGS. 1 and 2 is readily modified by adding additional metallization layers, using conventional CMOS fabrication techniques. In particular, it may be advantageous for at least some applications to add a ground plane on a new M1 layer beneath the top metal layer (i.e., beneath the layer shown in FIGS. 1 and 2 and labeled as the M1 layer in the illustrated implementation).

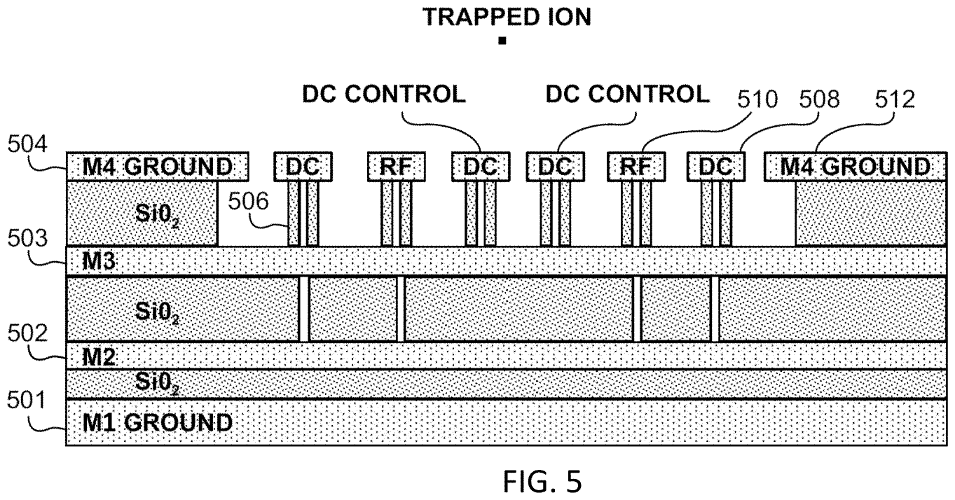

For example, FIG. 5 provides a notional cross-sectional view of a more recent fabrication technology for ion traps that uses four metallization layers 501, 502, 503, 504, i.e., M1-M4. The respective layers are separated by oxide pillars. Connections are made among the layers with tungsten via interconnects. FIG. 5 is not drawn to scale, and various simplifications have been made for clarity of presentation.

The electrodes in the top metal (M4) overhang their supporting oxide walls 506, as described above. These overhangs are beneficial for, among other things, shielding the trapped ions from stray charges on the dielectric surfaces.

The DC and RF trap electrodes 508, 510 are fed by buried metal lines on M2. Microwave signals for controlling state transitions may be delivered by buried transmission lines on M3 and shielded by a surface ground plane 512 on M4.

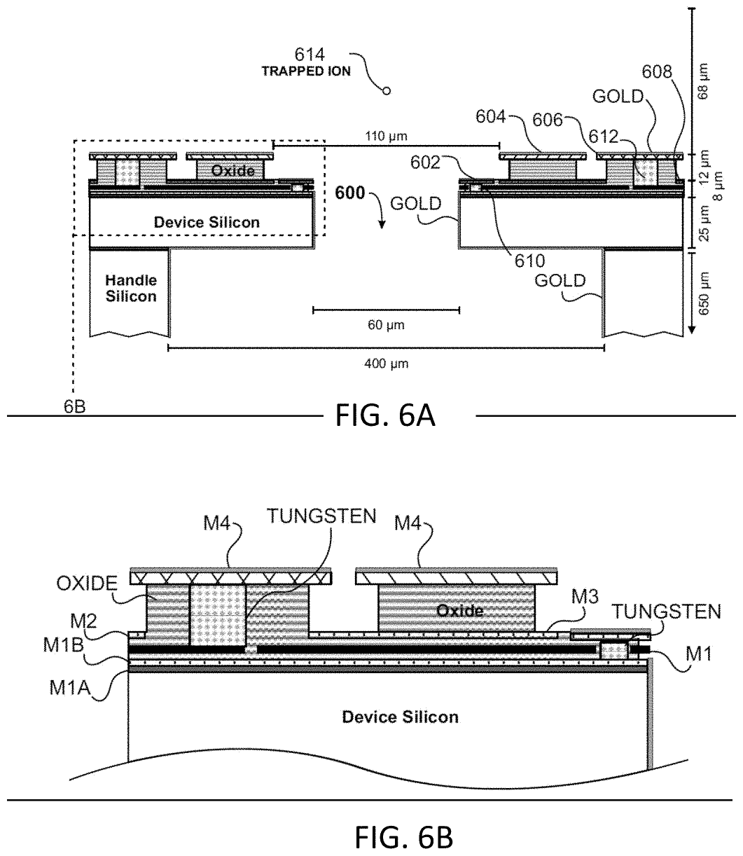

FIGS. 6A and 6B provide a more realistic drawing, approximately to scale, of the slotted quantum region of an ion trap fabricated in four metallization layers. FIG. 6B is a detail of FIG. 6A. The metallization layer M1A is a diffusion barrier of titanium nitride. The other metallization layers (i.e., M1B, M2, M3, and M4) are composed of aluminum alloyed with 0.5% copper. The non-limiting example that is illustrated has a 60-μm-wide slot 600 in the quantum region. In sequence from the center of the slot, the electrodes shown in the drawing are: DC control electrodes 602 in M3, RF electrodes 604 in M4, DC control electrodes 606 in M4, and a ground plane 608 in M3. Each inner DC electrode 602 is seen to be connected by tungsten vias 610 to the M1 level, and each outer DC electrode 606 is seen to be connected by tungsten vias 612 to the M2 level. Typical thicknesses are indicated on the drawing, including the height of the trapped ion 614 above the M4 level. The metallization levels and the exposed dielectric surfaces are overcoated with gold.

A still more recent advance in fabrication technology for ion traps uses six metallization layers. The additional metal layers provide more routing space to connect electrodes, which may be densely distributed, to the bond pads situated near the edges of the trap chip. By adding more metal layers, we can also increase the dielectric thickness between the RF electrodes and the ground planes. This has the benefit of reducing the overall capacitance of the RF electrode without sacrificing chip area that might be needed for the lithographic definition of structural features such as silicon dioxide support pillars for the electrodes.

In a non-limiting example of the six-level technology, electrodes are provided on the top metal (M6) layer, shielding is provided by ground planes on the next two layers (M5 and M4), signal routing is provided by traces on the next two layers (M3 and M2), and a ground plane is provided on the bottom layer (M1).

The RF electrode as shown in the preceding figures extends to bond pads at the periphery of the trap chip.

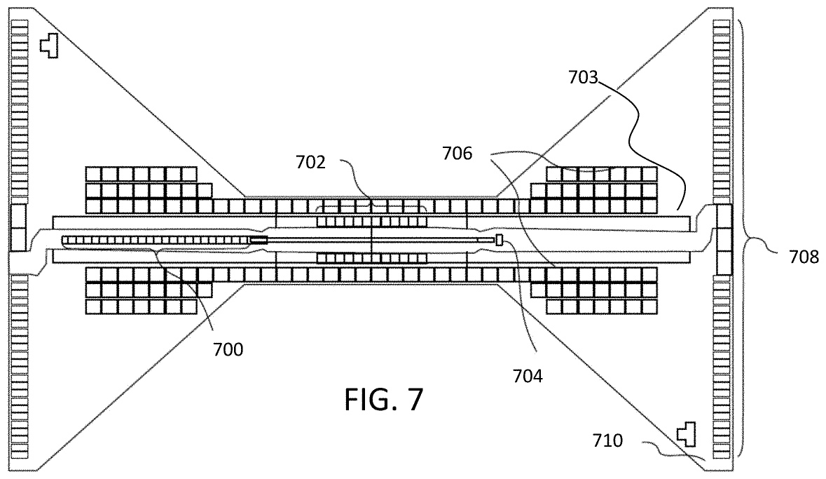

FIG. 7 is an illustrative example of a complete ion trap chip having a linear trap, shown in plan view. Features shown in the figure include the loading region 700 and the quantum region 702 of the chip, the RF electrode 703, a capacitive sensor 704 for measuring the RF voltage amplitude, and a bank 706 of onboard RF shunt capacitors that are integrated directly on the chip. Wirebond blocks 708 for input and output are also shown. Also indicated on the figure is a possible location 710 for thermoresistive temperature-sensing wires and resistive heating wires (not shown explicitly in the drawing). In the figure, the RF electrode is seen to terminate at bond pads at each of the two opposing ends of the chip.

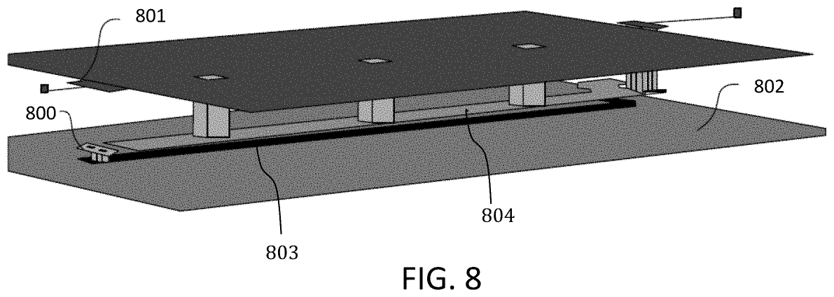

As mentioned above, we have found that it is advantageous to suspend the RF electrode in order to reduce its capacitance and related dissipative effects that cause unwanted heating. FIG. 8 is a cutaway perspective view of a portion of a suspended RF electrode 801. The portion visible in the figure is shown supported by four pillars of silicon dioxide, the rest of the underlying intermetal dielectric having been removed by etching. The figure also shows a capacitively coupled sensor 800 used for measuring the voltage amplitude of the RF signal, and ground plane 802.

The RF electrode of FIGS. 7 and 8 is fabricated in the top metal layer of the chip. Although such top-level RF electrodes are a subject of current study, other designs are also possible, in which the RF electrode occupies a lower metallization level and in which the RE electrode may even be overlain by metal in a higher level. Hence, designs in which the RF electrode is formed in a metallization level below the top level are not excluded from the scope of the present invention.

In the example of FIG. 8, the top metal layer is the layer M4. For amplitude measurement, a capacitively coupled sensor plate is fabricated in the M3 804 and M2 803 metal layers. The sensor signal is passed vertically through vias from M3 804 to M2 803 and extracted on a lead fabricated in M2 803.

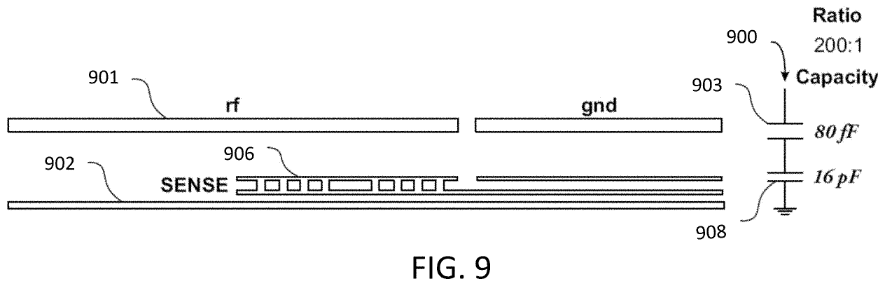

FIG. 9 is an elevational sectional view showing a detail of the sensor 900. It will be seen that the sensor is constituted as a capacitive voltage divider, with an upper capacitance 903 between the RF electrode 901 and the sensor plate 906, and a lower capacitance 908 between the sensor plate and a ground plane 902 in M1.

The signal from the sensor plate is routed out of the device on a trace on M2 that passes through a ground channel between ground planes. The pertinent ground planes in the example of FIGS. 8 and 9 are formed in M1 and M3. The lower capacitance is realized by the sensor routing trace and its surrounding ground planes.

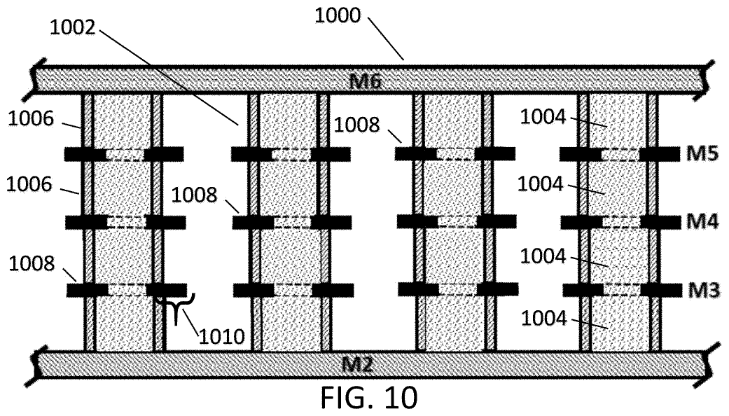

An RF electrode in another example is shown in FIG. 10. FIG. 10 is a cartoon drawing of a partial cross-section of an ion-trap chip in a region that includes part of the RF electrode. The view, which is notional only and not to scale, shows the top five metallization levels (i.e., M2-M6) of a six-level chip. It should be understood, however, that this drawing is intended solely as an illustrative example and is not meant to be limiting in any respect.

With further reference to the figure, it will be seen that the RF electrode 1000 is formed in the top metal layer, i.e., the M6 metal layer, and that the longitudinal axis of the RF electrode runs across the figure view from left to right. It will be seen that each of the support pillars 1002 is constituted by a sequence of intermetal dielectric (e.g., silicon dioxide) layers 1004 formed between M2 and M3, M3 and M4, M4 and M5, and M5 and M6, respectively.

The selective etching process that forms the pillars will be described below. As will be explained, the oxide that will constitute each of the pillars is encased in an etch stop (of tungsten, for example) to protect it from the etchant that removes the surrounding oxide. The figure shows these etch stops 1006 in place before they are removed by a selective etchant.

The metallization 1008 at each intermediate position within each pillar (i.e., the metallization at levels M3, M4, and M5 in the example of FIG. 10) forms an annulus that wraps all the way around the oxide portion of its pillar. Each of these annuli extends beyond the outer boundary of the pillar oxide to form a metal overlap 1010 that extends into the void between pillars. Each annulus provides a land onto which the next higher tungsten etch stop is deposited. The RF electrode also extends beyond the outer boundaries of its supporting pillars, thus forming an overlap that extends perpendicular to the plane of the figure.

The annular lands are grounded through vias to a ground plane.

### PROCESS DESCRIPTION

An example device can be made using techniques of deposition, patterning, and etching that are known from back-end-of-line (BEOL) CMOS fabrication technology. A useful reference in this regard is R. Jacob Baker, CMOS Circuit Design, Layout, and Simulation, Revised Third Edition, John Wiley & Sons (2008), Volume 1, Chapter 7, “CMOS Fabrication by Jeff Jessing,” pp. 161-212, particularly at pages 206-211.

Another useful reference is U.S. Pat. No. 6,893,578, issued to P.J. Clews et al. on May 17, 2005 under the title, “Selective Etchant for Oxide Sacrificial Material in Semiconductor Device Fabrication,” which is commonly owned herewith, and which is hereby incorporated herein in its entirety.

U.S. Pat. No. 6,893,578 describes a method of wet etching for semiconductor device fabrication that is useful in the present context. As described there, oxide sacrificial material is removed using an etching solution comprising a mixture of hydrofluoric acid (HF) and sulfuric acid (H2504). The hydrofluoric acid concentration according to the above-cited patent is generally in the range of 40-50% by weight HF, and the sulfuric acid concentration is generally at least 90% by weight H₂SO₄.

The hydrofluoric acid and sulfuric acid in the etching solution can be provided in a ratio HF:HSO that ranges from 1:3 to 3:1 or more, and preferably in the range of 1:1 to 3:1. These ratios in the range of 1:3 to 3:1 provide an etch selectivity greater than 100 for the oxide sacrificial material relative to a metal layer that comprises aluminum, such as an aluminum-5% copper metal layer. Etching can be performed with the etching solution at a temperature anywhere in the range of 5° -70° C.

The principle of selective etching to create dielectric support pillars is described, for example, in D. Stick (2010), which was cited above.

In an example implementation, the intermetallic dielectric layers are grown on a silicon wafer in multiple stages of plasma-enhanced chemical vapor deposition (PECVD) of silicon dioxide. The six metallization layers M1-M6 are vapor-deposited aluminum-5% copper. Electrical vias are formed by conventional vapor deposition of tungsten.

The pillars that support the RF electrode are defined by depositing vertical etch-stop layers of tungsten, as mentioned above. We refer to these etch stops as etch-stop “vias” because they can be deposited concurrently with electrical vias using the same process.

Each level of intermetal dielectric is polished flat by CMP prior to the tungsten deposition, and then subjected to a tungsten CMP after the vias (including etch-stop vias) are deposited.

After forming the RF electrode and other metal features on M6, the HF etch is performed to remove all of the sacrificial oxide in a single step. Etch holes formed through the RF electrode facilitate the entry of the HF etchant.

The tungsten etch stops are then removed using a conventional hydrogen peroxide wet etch.

### EXAMPLE

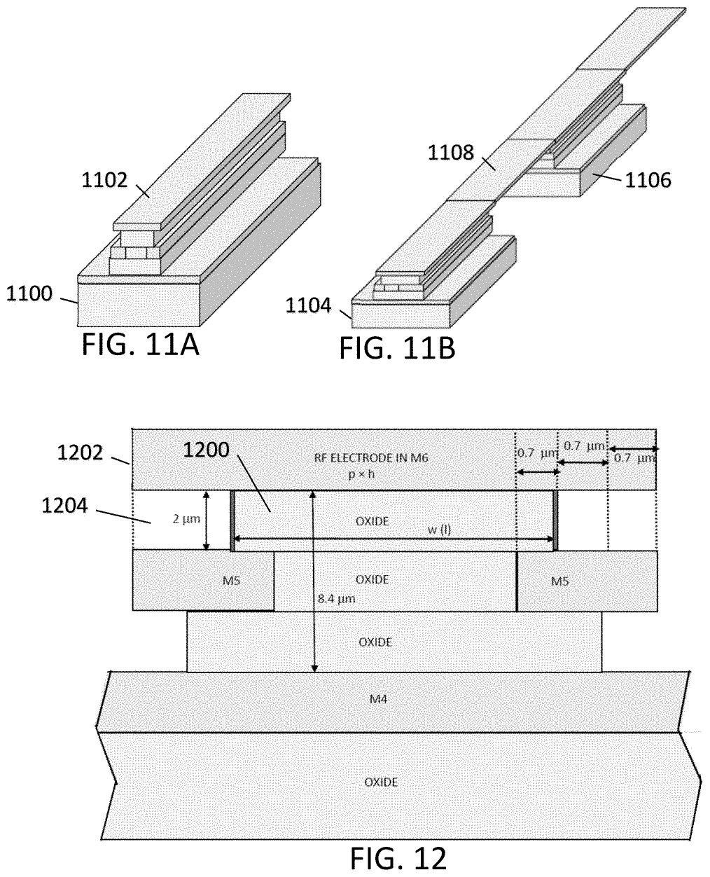

FIGS. 11A, 11B, and 12 show a portion of an RF electrode in an example implementation. FIG. 11A is a perspective view of one pillar 1100 together with the overlying portion 1102 of the RF electrode. FIG. 11B is a perspective view of two pillars 1104, 1106 together with the overlying span 1108 of the RF electrode. FIG. 12 is a view of a pillar in cross-section. The figures are notional only, and they are not drawn to scale.

We performed mathematical modeling on the RF electrode of FIGS. 11 and 12 in order to find favorable design parameters with respect to capacitance, heating, and mechanical vibration.

In our design study, we assumed a thickness of 2 μm for the intermetal oxide dielectric 1200 between M5 and M6, and a total oxide thickness of 8.4 μm between M4 and M6. We also assumed a basic unit of 0.7 μm for the overlap distance. We let the RF electrode 1202 overlap the M5-M6 oxide by two units (i.e., a horizontal distance of 1.4 μm), and we let the oxide overlap the M5 metal by one unit (i.e., a horizontal distance of 0.7 μm). Accordingly, the 2-μm-thick layer of dielectric between the RF electrode and the M5 metal consisted of an oxide portion 0.7 μm wide and a vacuum portion 1204 1.4 μm wide.

In the design study, the support ratio, i.e., the ratio of RF electrode area supported by oxide to total RF electrode area, was maintained at 1:3. According to our estimate, that ratio (assuming a silicon dioxide dielectric) would minimize the steady-state operating temperature of the RF electrode. A smaller ratio would lead to a temperature increase due to reduced heat sinking, whereas a larger ratio would lead to a temperature increase due to increased capacitance.

Our design study was limited by particular choices of materials and layer thicknesses. Given a greater variety of design choices, a range of support ratios could be effective. As a general rule, however, it will be desirable for at least 50% of the total RF electrode area to be unsupported. In other words, the RF electrode will generally have a support ratio (supported area:total area) of 1:2 or less. Although even smaller ratios may be achievable, a ratio of 1:100 is believed to approach the limit of what is mechanically feasible.

The design parameters that we varied were the pitch of the support pillars and the length of the pillars in the longitudinal direction of the RF electrode. We also examined how changing the metal thickness of the RF electrode would affect deflection and mechanical resonance.

The range of pitches considered in our design study was 35 μm -100 μm. This range encompasses typical values for the length of an RF electrode span, given the particular materials and layer thicknesses chosen for our design study. However, these values should be understood as exemplary only, and as non-limiting.

The performance measures we examined were capacitance, steady-state operating temperature, electrostatic deflection, and mechanical resonant frequency. The capacitance is presented here as a relative quantity compared to a hypothetical baseline device having a continuous dielectric support structure under the RF electrode.

The baseline device is not described here in detail. However, it should be noted that in fabrication efforts, we have built up thick layers of oxide in successive depositions of oxide layers that are, e.g., 2 μm thick. To achieve acceptable results, we have found it desirable to include some metal between each pair of these layers, thus leading to metallization at M2, M3, etc. Hence, a practical realization of our hypothetical baseline device would contain metallization within the continuous dielectric support structure, and that metallization is predicted to increase the capacitance by 33%.

We modeled capacitance (as a fraction of the hypothetical baseline device capacitance) as a function of the pitch of the support pillars, taking as a representative design an RF electrode width (perpendicular to the longitudinal direction) of 100 μm and a pillar width (also perpendicular to the longitudinal direction) of 79 μm. We found that the capacitance decreased monotonically with pitch, and that it showed a stronger dependence below about 100 μm and a weaker dependence above that value. We also modeled the capacitance as a function of the pillar width. We found a near-linear increase in the capacitance as the pillar width increased.

According to a simple estimate, the steady-state operating temperature of the RF electrode is proportional to the square of the capacitance, divided by the pillar area. From that estimate, we predicted that the temperature would fall with increasing pillar length (in the longitudinal direction) up to about 40 μm, after which it would level off or rise gradually.

We modeled the steady-state operating temperature of the RF electrode, assuming an input voltage of 100V at a frequency of 100 MHz.

Our modeling of capacitance and temperature led to the values listed in Table 1 for selected combinations of design parameters. The capacitance fraction is expressed as a percentage of the capacitance of the baseline device. The column of the table labeled “Heat unit cell” lists the predicted electric power that is dissipated as heat, per unit cell of the structure. A unit cell may be defined, e.g., as the portion extending toward the right, from the left-hand edge of one pillar to the left-hand edge of the next pillar. The maximum temperature differential (Max AT) is the modeled maximum temperature difference between the RF electrode and an underlying silicon dioxide dielectric. It would be desirable to make Max ΔT as small as possible.

TABLE 1

| | Pillar | Capacitance | Heat unit | |
|---|---|---|---|---|
| Pitch | Length | fraction | cell | Max ΔT |
| 35 | 10 μm | 96% | 32.2 μW | 0.46K |
| 70 | 30 μm | 93% | 60.5 μW | 0.31K |
| 50 | 15 μm | 88% | 38.7 μW | 0.37K |
| 80 | 30 μm | 87% | 60.5 μW | 0.31K |
| 70 | 20 μm | 80% | 44.8 μW | 0.34K |
| 100 | 30 μm | 76% | 57.8 μW | 0.30K |

We modeled the average downward force on the RF electrode due to an RF voltage of 300V. Table 2 lists the force on a single span of the RF electrode between pillars, and it also lists the maximum deflection of that span due to the electrical force for various combinations of design parameters. An electrode thickness of 1.2 μm is assumed.

TABLE 2

| | Pillar | Capacitance | Force on unit | Max |
|---|---|---|---|---|
| Pitch | length | fraction | cell (300 V) | amplitude |
| 35 | 10 μm | 96% | 0.64 mN | 84 nm |
| 70 | 30 μm | 93% | 1.24 mN | 231 nm |
| 50 | 15 μm | 88% | 0.84 mN | 151 nm |
| 80 | 30 μm | 87% | 1.32 mN | 414 nm |
| 70 | 20 μm | 80% | 1.06 mN | 384 nm |
| 100 | 30 μm | 76% | 1.44 mN | 1116 nm |

Excessive deflection is undesirable because it can change the equilibrium height of the trapped ion. Our studies showed, however, that deflections of 151 nm or less (and possibly also somewhat greater deflections) would be acceptable. In that regard, we found that a design having a pitch of 50 μm and a pillar length of 15 μm would yield a predicted deflection of 151 nm and a relatively low capacitance fraction of 88%. Because it offered such a favorable combination of performance measures, we chose that design for further study.

We also modeled the mechanical resonances of the RF electrode. The minimum resonance frequency that we predicted for each of various combinations of design parameters is listed in Table 3. In the event that mechanical resonances are exhibited in operation of the ion trap, it is desirable that the resonant frequencies be well separated from the secular frequencies of the trapped ion. In the study reported here, we hoped to find that the resonant frequencies would be higher than the secular frequencies of interest. (The first row of Table 3 relates to the hypothetical baseline device in a practical realization that includes intermediate metallization, which raises the capacitance. The second row of the table relates to the idealized baseline device that contains no intermediate metallization.

TABLE 3

| | Pillar | Capacitance | | Max | Min resonance | |
|---|---|---|---|---|---|---|
| Pitch | length | fraction | Max ΔT | deflection | freq | |
| ∞ | | 133% | 0.15K | 36 nm | ≈9 | MHz |
| Phoenix | | 100% | | | ≈9 | MHz |
| 35 | 10 μm | 96% | 0.46K | 84 nm | 7.1 | MHz |
| 70 | 30 μm | 93% | 0.31K | 231 nm | 3.3 | MHz |
| 50 | 15 μm | 88% | 0.37K | 151 nm | 4.0 | MHz |
| 80 | 30 μm | 87% | 0.31K | 414 nm | 2.3 | MHz |
| 70 | 20 μm | 80% | 0.34K | 384 nm | 2.3 | MHz |
| 100 | 30 μm | 76% | 0.30K | 1116 nm | 1.3 | MHz |

Typical secular frequencies are in the range 1-20 MHz, which roughly coincides with the minimum frequencies predicted by our modeling study. However, our modeling studies also showed that all of the predicted resonances are substantially damped out that if the material of the RF electrode has an internal damping coefficient (i.e., the imaginary part of the stiffness coefficient) that is at least 2×10⁻⁷. For an aluminum RF electrode, the internal damping coefficient is expected to be roughly 2×10⁻⁵. This gives us confidence that the ion trap can be operated with no significant interference from mechanical resonance.

Taking as a baseline the design with a pitch of 50 μm and a pillar length of 15 μm, we modeled some effects of doubling the RF electrode metal thickness from 1.2 μm to 2.4 μm, and the effect of perforating the RF electrode with holes for the introduction of the etchant that would suspend the RF electrode by removing oxide material. We have, in fact, considered fabricating a design using an RF electrode that is 2.4 μm or 2.5 μm thick, and even greater thicknesses are possible. The etch holes are a desirable feature for facilitating the introduction of the oxide etchant.

Table 4 shows the results of that study. As seen, doubling the metal thickness did not significantly affect the capacitance, but it reduced the maximum deflection by sixfold, and it almost doubled the minimum resonant frequency. We observed no effect from the etch holes on the deflection or on the resonant frequency.

TABLE 4

| | | | | Min | |
|---|---|---|---|---|---|
| Pillar | Capacitance | Metal | Max | resonance | |
| length | fraction | thickness | deflection | frequency | Comment |
| 15 μm | 88% | 1.2 μm | 151 nm | 4.0 MHz | |
| 15 μm | 88% | 2.4 μm | 25 nm | 7.5 MHz | |
| 15 μm | 88% | 2.4 μm | 25 nm | 7.5 MHz | Etch holes |

1. A method for forming an ion trap chip, the ion trap chip including an RF electrode including at least two spans, each of the at least two spans suspended from a first respective support pillar to a second respective support pillar, the method comprising the steps of:
forming a first metal layer on a substrate;
forming a first intermetal dielectric layer on the first metal layer;
etching a first plurality of closed-loop etch-stop via openings through the first intermetal dielectric layer;
filling the first plurality of closed-loop etch-stop via openings with sacrificial metal to thereby form a first plurality of vertical etch-stop vias and a first plurality of protected intermetal dielectric columns, each of the first plurality of protected intermetal dielectric columns surrounded by a corresponding one of the first plurality of vertical etch-stop vias;
forming a second metal layer on the first intermetal dielectric layer;
removing a portion of the second metal layer between adjacent ones of the first plurality of vertical etch-stop vias to form a first plurality of etch holes;
forming a second intermetal dielectric layer on the second metal layer;
etching a second plurality of closed-loop etch-stop via openings through the second intermetal dielectric layer;
filling the second plurality of closed-loop etch-stop via openings with sacrificial metal to thereby form a second plurality of vertical etch-stop vias and a second plurality of protected intermetal dielectric columns, each of the second plurality of protected intermetal dielectric columns surrounded by a corresponding one of the second plurality of vertical etch-stop vias;
forming a third metal layer on the second intermetal dielectric layer, the third metal layer including a second plurality of etch holes between the second plurality of vertical etch-stop vias;
removing a portion of the third metal layer to form a second plurality of etch holes;
simultaneously selectively etching the first intermetal dielectric layer between adjacent ones of the first plurality of vertical etch-stop vias using the first plurality of etch holes, and the second intermetal dielectric layer between adjacent ones of the second plurality of vertical etch-stop vias using the second plurality of etch holes; and
subsequently simultaneously selectively removing the first plurality of vertical etch-stop vias and the second plurality of vertical etch-stop vias to thereby form the support pillars from which the at least two spans are suspended, each support pillar including a corresponding one of the first plurality of protected intermetal dielectric columns and a corresponding one of the second plurality of protected intermetal dielectric columns.

2. The method of claim 1, wherein each of the first metal layer, the second metal layer, and the third metal layer includes aluminum.

3. The method of claim 1, wherein each of the first intermetal dielectric layer and the second intermetal dielectric layer includes at least one of silicon dioxide, aluminum nitride, silicon nitride, alumina, diamond, or silicon carbide.

4. The method of claim 1, wherein the sacrificial metal includes tungsten.

5. The method of claim 1, wherein the step of removing a portion of the third metal layer forms the RF electrode.

6. The method of claim 1, wherein the step of simultaneously selectively etching the first intermetal dielectric layer employs hydrofluoric acid.

7. The method of claim 1, wherein the step of simultaneously selectively removing the first plurality of vertical etch-stop vias employs hydrogen peroxide.

8. The method of claim 1, wherein:
a shape and a size of each of the first plurality of vertical etch-stop vias is the same as a shape and a size of the second plurality of vertical etch-stop vias; and
each of the second plurality of vertical etch-stop vias is directly underlain by a respective one of the first plurality of vertical etch-stop vias.

9. The method of claim 1, wherein
a shape of each of the first plurality of vertical etch-stop vias is the same as a shape of the second plurality of vertical etch-stop vias; and
a size of each of the first plurality of vertical etch-stop vias is different from a size of the second plurality of vertical etch-stop vias.

10. The method of claim 1, wherein a shape of each of the first plurality of vertical etch-stop vias and a shape of each of the second plurality of vertical etch-stop vias is one of a circle or a rectangle.

11. The method of claim 1, wherein a distance between adjacent ones of the support pillars is between 35 μm and 100 μm.

12. The method of claim 1, further comprising, after the step of filling the second plurality of etch-stop via openings, the steps of:
forming a fourth metal layer on the second intermetal dielectric layer, the fourth metal layer including a third plurality of etch holes between the second plurality of vertical etch-stop vias;
forming a third intermetal dielectric layer on the fourth metal layer, the fourth metal layer and the third intermetal dielectric layer thereby located between the second intermetal layer and the third metal layer;
etching a third plurality of etch-stop via openings through the third intermetal dielectric layer; and
filling the third plurality of etch-stop via openings with sacrificial metal to thereby form a third plurality of vertical etch-stop vias;
wherein:
the step of simultaneously selectively etching the first intermetal dielectric layer further includes simultaneously selectively etching the third intermetal dielectric layer between adjacent ones of the third plurality of vertical etch-stop vias using the third plurality of etch holes; and
the step of simultaneously selectively removing the first plurality of vertical etch-stop vias further includes simultaneously selectively removing the third plurality of vertical etch-stop vias.

13. A method for forming intermetal dielectric columns, the method comprising the steps of:
forming a first metal layer on a substrate;
forming an intermetal dielectric layer on the first metal layer;
etching a plurality of closed-loop etch-stop via openings through the intermetal dielectric layer;
filling the plurality of closed-loop etch-stop via openings with sacrificial metal to thereby form a plurality of vertical etch-stop vias and a plurality of protected intermetal dielectric columns, each of the plurality of protected intermetal dielectric columns surrounded by a corresponding one of the plurality of vertical etch-stop vias;
forming a second metal layer on the first intermetal dielectric layer;
removing a portion of the second metal layer between adjacent ones of the plurality of vertical etch-stop vias to form a plurality of etch holes;
selectively etching the intermetal dielectric layer between adjacent ones of the plurality of vertical etch-stop vias using the plurality of etch holes; and
subsequently selectively removing the plurality of vertical etch-stop vias to thereby form the intermetal dielectric columns.

14. The method of claim 13, wherein each of the first metal layer and the second metal layer includes aluminum.

15. The method of claim 13, wherein the intermetal dielectric layer includes at least one of silicon dioxide, aluminum nitride, silicon nitride, alumina, diamond, or silicon carbide.

16. The method of claim 13, wherein the sacrificial metal includes tungsten.

17. The method of claim 13, wherein the step of selectively etching the intermetal dielectric layer employs hydrofluoric acid.

18. The method of claim 13, wherein the step of selectively removing the plurality of vertical etch-stop vias employs hydrogen peroxide.

19. The method of claim 13, wherein a shape of each of the plurality of vertical etch-stop vias is one of a circle or a rectangle.

20. The method of claim 13, wherein a distance between adjacent ones of the intermetal dielectric columns is between 35 μm and 100 μm.
